(19) United States
(12) Patent Application Publication
(10) Pub. No.: US 2006/0268815 A1
(43) Pub. Date: Nov. 30, 2006

(54) Communication apparatus and communication controlling method

(75) Inventor: Kazuya Fukushima, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/417,061

(22) Filed: May 4, 2006

(30) Foreign Application Priority Data
May 31, 2005 (JP) 2005-160673

(51) Int. Cl. H04B 7/212

(52) U.S. Cl. 370/347; 370/401

(57) ABSTRACT

According to one embodiment, an access point selects channels from a plurality of odd-number and even-number communication channels and allocates the selected channels to terminal, in accordance with a radio communication environment. In allocation, the access point allocates the odd-number communication channels in increasing order of frequency, and the even-number communication channels in decreasing order of frequency.

### CROSS-REFERENCE TO RELATED APPLICATIONS

This application is based upon and claims the benefit of priority from Japanese Patent Application No. 2005-160673, filed May 31, 2005, the entire contents of which are incorporated herein by reference.

### BACKGROUND

1. Field

The present invention relates to a communication apparatus and a communication control method relating to a radio communication technique, in which odd-number communication channels and even-number communication channels are used together, preventing interference of frequencies and enabling efficient setting of a communication channel.

2. Description of the Related Art

Access Points are known as a communication apparatus which establishes connection between terminals such as personal computers (PC) and a network. Radio communication between the terminals and access points is established through a radio LAN (Local Area Network). In this case, access points perform radio communication with the terminals by using channels corresponding to certain frequency bands. In a system in which a plurality of such access points are provided, it is necessary to allocate channels to access points to prevent radio interference between the access points as much as possible. This is because radio interference causes decrease in throughput.

Further, with amendment of The Radio Law in Japan, the communication frequencies for 5 GHz band of radio LANs have been changed, and thereby the conventional odd-number communication channels are being changed to even-number communication channels. During a transition period, the odd-number communication channels and the even-number communication channels are used together (see http://bb.watch.impress.co/jp/cda/news/7817.html).

In the above structure, there is the possibility that frequency interference occurs between the conventional odd-number communication channels and the new even-number communication channels.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram illustrating an example of a schematic structure of a radio LAN system to which a communication apparatus according to a first embodiment of the present invention is applied;

FIG. 2 is a block diagram illustrating an example of a structure common to access points shown in FIG. 1 according to the first embodiment;

FIG. 3 is a block diagram illustrating an example of a functional structure of a host access point shown in FIG. 1 according to the first embodiment;

FIG. 4 is a schematic diagram of an example of channel information stored in a channel information storage area of a storage section according to the first embodiment;

FIG. 5 is a diagram illustrating an example of a channel allocation setting table according to the first embodiment;

FIG. 6 is a diagram illustrating an example of a schematic structure of a radio LAN system to which a communication apparatus according to a second embodiment of the present invention is applied according to the first embodiment; and

FIG. 7 is a diagram of a sequence, illustrating operation of a host access point and operation of non-host access points shown in FIG. 6 according to a second embodiment of the invention.

### DETAILED DESCRIPTION

Various embodiments according to the invention will be described hereinafter with reference to the accompanying drawings. In general, according to one embodiment of the invention, there is provided a communication apparatus which performs radio communication with one or more external communication devices by using a plurality of odd-number communication channels and a plurality of even-number communication channels corresponding to certain frequency bands, comprising: control unit which allocats the odd-number communication channels in increasing order of frequency and allocating the even-number communication channels in decreasing order of frequency, if channels used for the radio communication with the external communication devices are allocated from among the odd-number communication channels and the even-number communication channels, in accordance with a radio communication environment; and communication unit which performs the radio communication with the external communication devices by using the communication channels allocated by the control unit.

According to the present invention it is possible to provide a communication apparatus and a communication control method relating to a radio communication technique, in which odd-number communication channels and even-number communication channels are used together, preventing interference of frequencies and enabling efficient setting of a communication channel.

### First Embodiment

Embodiments of the present invention are explained below with reference to drawings.

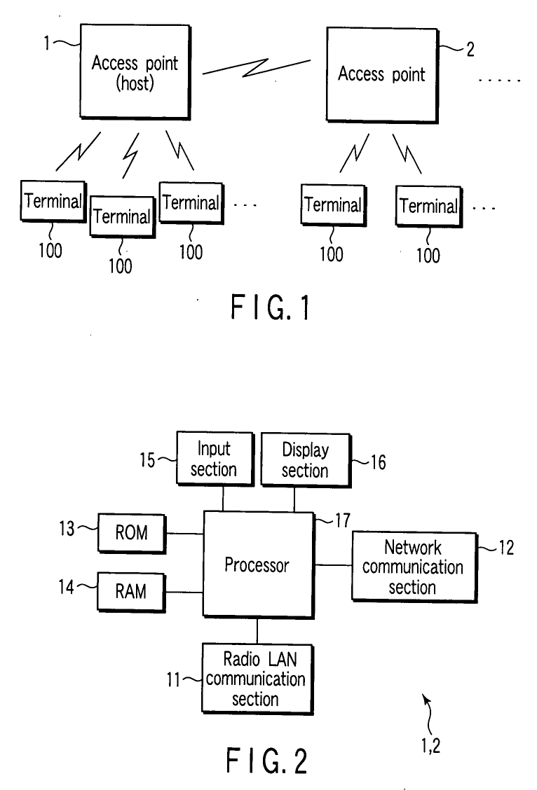

FIG. 1 is a diagram illustrating an example of a schematic structure of a radio LAN system to which a communication apparatus according to a first embodiment of the present invention is applied.

The system comprises an access point (communication apparatus) 1 operating as a host, and at least one access point (non-host access point) 2 other than the host. In this example, assume that a plurality of access points exists.

Each access point is a communication apparatus which performs radio communication with terminals (external communication devices: client terminals being electronic apparatuses such as personal computers and PDAs) 100 through a radio LAN, by using channels corresponding to certain frequency bands, and connects the terminals 100 with other radio communication media and wired communication media (such as the Internet, LANs), not shown.

In the case where the access point 1 cannot function as a host (for example, in the case where the access point 1 is not powered or any trouble occurs), one of the access points 2 can detect it and operate as a host instead of the access point 1. In the first embodiment, explained is the case where the access point 1 always acts as the host.

FIG. 2 is a block diagram illustrating an example of a structure common to the access points shown in FIG. 1.

Each of the access points 1 and 2 comprises a radio LAN communication section 11, a network communication section 12, a ROM (Read Only Memory) 13, a RAM (Random Access Memory) 14, an input section 15, a display section 16, and a processor 17.

The radio LAN communication section 11 performs radio communication with the terminals 100 existing in a range, in which the radio wave from the access point reaches, and other access points through the radio LAN. The network communication section 12 performs communication with other communication media (the Internet, LANs, etc.) not shown.

The ROM 13 stores a control program and tables used by the processor 17. The RAM 14 is used as a work area of the processor 17. While the access point is operated, the control program and the tables used by the processor 17 are resident in the RAM 14.

The input section 15 is used for operation such as power-up and reset. Further, each access point is configured such that the output level of radio waves transmitted by radio from the access point can be controlled by operating the input section 15. Each access point may be configured such that this control is performed by a terminal which is connected to the access point by radio. The display section 16 displays a state of the access point and the like.

The processor 17 controls operation of the whole access point, and performs communications with other access points and internal processing (such as management of the tables) in accordance with the control program, for example.

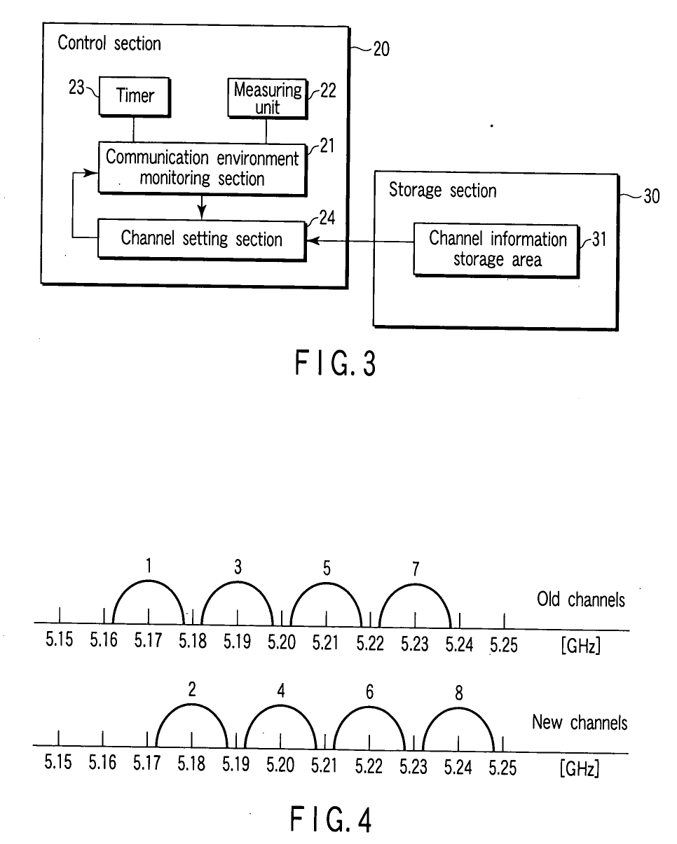

FIG. 3 is a block diagram illustrating an example of a functional structure of the host access point 1 shown in FIG. 1.

A control section 20 is realized by the processor 17 (refer to FIG. 2), which executes the control program. The control section 20 comprises a communication environment monitoring section 21, a measuring section 22, a timer 23, and a channel setting section 24.

A storage section 30 is realized by the RAM 14 (refer to FIG. 2) which stores various channel information (described later). The storage section 30 has a channel information storage area 31.

The communication environment monitoring section 21 performs channel setting on the basis of channel information from the terminals 100. Further, communication environment monitoring section 21 monitors the ambient communication environment (in particular, the radio wave environment with the terminals 100), during initial operation such as when the access point 1 is powered on or reset, and at certain time intervals while the access point 1 is operated. For example, the communication environment monitoring section 21 monitors the load on the system, on the basis of the number of the access points 2 forming the communication system together with the access point 1, and the like. The communication environment monitoring section 21 can also monitor a bit error rate and a throughput of radio communications in the access point 1, and change in reception level of transmitted radio waves. Further, if these values exceed (or fall short of) their reference values, the communication environment monitoring section 21 detects it.

Furthermore, if the value of a parameter exceeds its threshold value in initial operation or during operation of the access point 1, the communication environment monitoring section 21 starts the channel setting section 24. For example, if the bit error rate of radio communication exceeds a predetermined value, the communication environment monitoring section 21 determines that it is necessary to change the channels allocated to the access point 1 and the other access points 2, and starts the channel setting section 24.

The measuring section 22 measures the bit error rate, the throughput, the radio wave reception level and the like. The timer 23 is used to count the time intervals of the monitoring processes performed in the communication environment monitoring section 21.

The channel setting section 24 selects one appropriate channel from a plurality of candidate channels listed in the channel information storage area 31 (described later) in the storage section 30, in view of the current communication environment (in particular, the radio wave environment, etc.).

According to the above structure, the control section 20 monitors the radio communication environment at regular time intervals after the access point 1 is powered on, and dynamically changes the channels allocated to the access point 1 and the access points 2 on the basis of the channel information from the terminals 100.

The channel information storage area 31 of the storage section 30 is a table used for channel setting performed in the channel setting section 24. The channel information storage area 31 stores information describing a plurality of channels whose frequency bands are separate from one another by at least a certain value.

FIG. 4 is a schematic diagram of an example of channel information stored in the channel information storage area 31 of the storage section 30.

With amendment of The Radio Law in Japan, the communication frequencies for 5 GHz band of radio LANs have been changed, and thereby the conventional odd-number communication channels are being changed to even number communication channels. Therefore, during a transition period, the odd-number communication channels and the even-number communication channels are used together. FIG. 4 illustrates a state where the odd-number communication channels and the even-number communication channels are used together. The access points 1 and 2 are compliant with both the odd-number and the even-number communication channels. Assume that the terminals 100 include terminals compliant with both the odd-number and the even-number communication channels and terminals compliant with either the odd-number or the even-number communication channels.

As shown in FIG. 4, the upper line shows old channels (odd-number channels 1, 3, 5 and 7), and the lower line shows new channels (even-number channels 2, 4, 6 and 8). The odd-number channel 1 corresponds to 5.17 GHz, the odd-number channel 3 corresponds to 5.19 GHz, the odd-number channel 5 corresponds to 5.21 GHz, and the odd-number channel 7 corresponds to 5.23 GHz. Further, the even-number channel 2 corresponds to 5.18 GHz, the even-number channel 4 corresponds to 5.20 GHz, the even-number channel 6 corresponds to 5.22 GHz, and the even-number channel 8 corresponds to 5.24 GHz. Specifically, the frequency bands of the channels are separate from one another by at least a certain value.

As described above, the channel information is stored in the channel information storage area 31 in the storage section 30.

If the odd-number channels are allocated to the terminals 100, the control section 20 allocates the odd-number channels in increasing order of frequency, that is, in the order of the odd-number channels 1, 3, 5 and 7. If the even-number channels are allocated to the terminals 100, the control section 20 allocates the even-number channels in decreasing order of frequency, that is, in the order of the even-number channels 8, 6, 4 and 2.

Further, the control section 20 allocates the channels such that the channels do not overlap. For example, in the above structure where the odd-number channels 1, 3, 5, and 7 are allocated in this order and the even-number channels 8, 6, 4, and 2 are allocated in this order, when the odd-number channels 1 and 3 and the even-number allocated 8 and 6 are allocated, the control section 20 do not allocate more channels, since the frequency band of the odd-number channel 3 is adjacent to the frequency band of the even-number channel 6. In the same manner, when the odd-number channel 1 and the even-number channels 8, 6, and 4 are allocated, the control section 20 does not allocate more channels, since the frequency band of the odd-number channel 1 is adjacent to the frequency band of the even-number channel 4.

As described above, the system is desirably configured to stop allocation of more channels, when the frequency band of the last allocated odd-number channel is adjacent to the frequency band of the last allocated even-number channel.

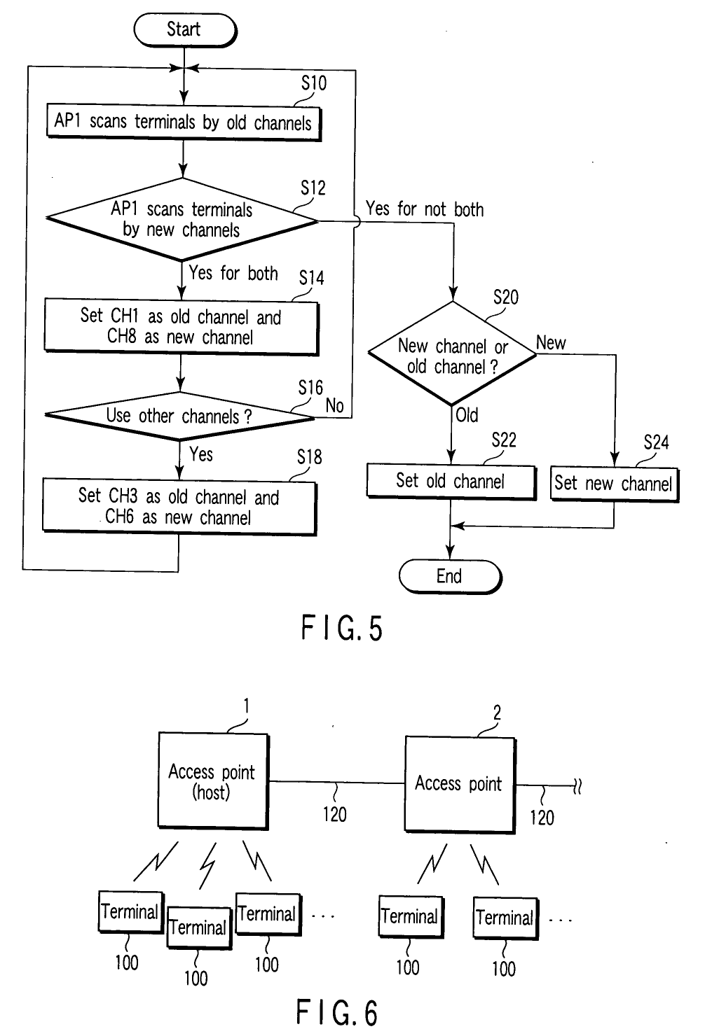

FIG. 5 is a flowchart illustrating an example of scanning the terminals 100 by using the new channels and the old channels, and setting the channels.

In step S10, the control section 20 of the access point 1 scans the terminals 100 by using the odd-number channels being the old channels. Next, in step S12, the control section 20 of the access point 1 scans the terminals 100 by using the even-number channels being the new channels.

As a result of the scans performed in step S10 and S12, if terminals in the terminals 100 which responded to the scans are regarded as being compliant with both the old channels and the new channels, the control section 20 allocates, to the responded terminals, one of the odd-number channels in increasing order of frequency, and one of the even-number channels in decreasing order of frequency. Specifically, the channel 1 is allocated as the old channel, and the channel 8 is allocated as the new channel.

In step S16, the control section 20 of the access point 1 determines whether other channels are also to be used or not. In step S16, if the control section 20 of the access point 1 determines that other channels are also to be used, the control section 20 allocates, to the remaining responded terminals, one of the non-allocated odd-number channels in increasing order of frequency, and one of the non-allocated even-number channels in decreasing order of frequency, in the same manner. Specifically, the channel 3 is allocated as the old channel, and the channel 6 is allocated as the new channel.

Further, if the frequency band of the last allocated odd-number channel is adjacent to the frequency band of the last allocated even-number channel, the control section 20 does not allocate more channels. Specifically, if the channel 3 is allocated as the old channel and the channel 6 is allocated as the new channel, the frequency band of the channel 3 is adjacent to the frequency band of the channel 6. Therefore, the control section 20 does not perform further allocation of the channels.

On the other hand, as a result of the scans performed in steps S10 and S12, if terminals in the terminals 100 which responded to the scans are not regarded as being compliant with both the old channels and the new channels, in step S20, the control section 20 of the access point 1 determines whether the responded terminals are compliant with the new channels or with the old channels. In step S20, if the control section 20 of the access point 1 determines that the responded terminals are compliant with the new channels, in step S22, the control section 20 allocates empty channels of the old channels to the responded terminals. If the control section 20 of the access point 1 determines that the responded terminals are compliant with the old terminals in step S20, the control section 20 allocates empty channels of the new channels to the responded terminals in step S24.

According to the above structure, it is possible to prevent interference between frequencies and efficiently set communication channels, even when the odd-number and the even-number communication channels are used together during the transition period, in which communication channels are switched from the conventional odd-number channels to the even-number channels due to change of frequencies of 5 GHz band of radio LANs with amendment of the Radio Law in Japan.

### Second Embodiment

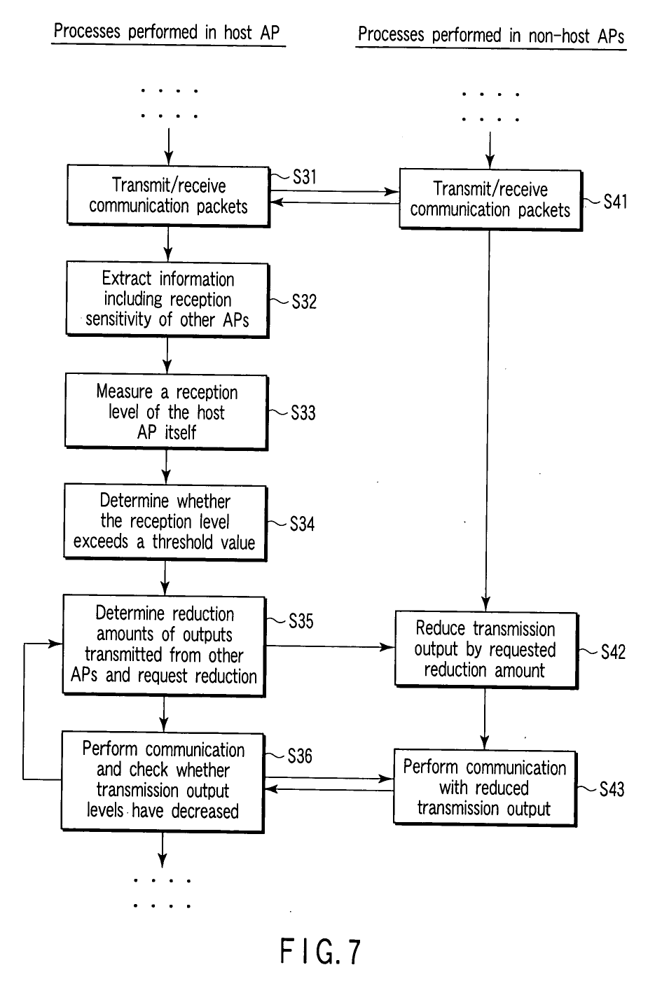

Next, a second embodiment of the present invention is explained with reference to FIGS. 6 and 7. Like reference numerals as in the first embodiment denote like constituent elements, and detailed explanation thereof is omitted.

FIG. 6 is a diagram illustrating an example of a schematic structure of a radio LAN system to which a communication apparatus according to a second embodiment of the present invention is applied. As shown in FIG. 6, the second embodiment is different from the first embodiment in that access points are connected by wired communication unit such as a wired LAN 120 to have various information in common.

FIG. 7 is a diagram of a sequence, illustrating operation of a host access point 1 and operation of non-host access points 2 shown in FIG. 6.

In the operation shown in FIG. 7, the access point 1 and the access points 2 perform transmission and reception (steps S31 and S41) of communication packets. In this step, the access point 1 transmits, to each access point 2, a command of requesting various information including information indicating a reception level of a radio wave received by each access point 2, through the wired LAN 120, for example. In response to the command, each access point 2 transmits various information, including information of its reception level, to the access point 1.

In step S32, the access point 1 extracts the reception level information of each access point 2 from the communication packets transmitted from the access points 2, and compares the reception level of each access point 2 with the reception level of the access point 1. As another example, the access point 1 compares an upper limit value of a reception allowable level shown in a reception sensitivity threshold table with the reception level of the access point 1. Thereby, the access point 1 determines whether the reception level of the access point 1 exceeds a threshold value (is too high) or not (step S34).

If the reception level exceeds the threshold value, the access point 1 determines that the output levels of radio waves transmitted from the corresponding access points 2 are too high, and determines a reduction amount of each of the output levels and set the amount on a transmission output setting table. Thereafter, in step S35, the access point 1 transmits an output level change command requesting the corresponding access points 2 to reduce their output levels. The command includes information indicating the reduction amount of the output level.

In step S42, the access points 2 which have received the output level change command reduce their output levels by the designated reduction amounts. Then, in step S43, the access points 2 perform radio transmission with the reduced output levels.

In step S36, the access point 1 measures the radio wave reception level of the access point 1 again, and thereby checks whether the output levels of the access points 2 have been reduced as requested. In this step, if the radio wave reception level of the access point 1 still exceeds the threshold value, the access point 1 determines that it is necessary to further reduce the output levels of the access points 2, and repeats the process of step S35. On the other hand, if the reception level does not exceed the threshold value, the access point 1 determines that the output levels of the access points 2 have reached a proper level, and ends the reduction processing of the output level.

Further, when the odd-number channels are allocated in increasing order of frequency and the even-number channels are allocated in decreasing order of frequency as explained in the first embodiment, the access points can share information of a distance from adjacent access point(s) through the wired LAN 120. For example, if the distance from the adjacent access point(s) is at least a predetermined distance, e.g., 100 m, the access point 1 determines that the adjacent access points do not interfere with each other. Then, even when the frequency band of the last allocated odd-number channel is adjacent to the frequency band of the last allocated even-number channel, the access point 1 continues to allocate the empty odd-number channels in increasing order of frequency and the empty even-number channels in decreasing order of frequency.

As described above, according to the second embodiment, the access points share various information, and thus it is possible to efficiently allocate communication channels. Further, interference of radio waves between access points is reduced, and the throughput is improved. Furthermore, it is possible to promptly and flexibly change allocation of channels in accordance with change in the radio wave environment and the like. It is also possible to avoid troubles in reception due to too high a radio wave level of an access point being a reception side.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus which performs radio communication with one or more external communication devices by using a plurality of odd-number communication channels and a plurality of even-number communication channels corresponding to certain frequency bands, comprising:
control unit which allocats the odd-number communication channels in increasing order of frequency and allocating the even-number communication channels in decreasing order of frequency, if channels used for the radio communication with the external communication devices are allocated from among the odd-number communication channels and the even-number communication channels, in accordance with a radio communication environment; and
communication unit which performs the radio communication with the external communication devices by using the communication channels allocated by the control unit.

2. A communication apparatus according to claim 1, wherein the control unit allocates the communication channels until a frequency band of a last allocated odd-number communication channel and a frequency band of a last allocated even-number communication channel are adjacent to each other.

3. A communication apparatus according to claim 1, further comprising:
wired communication unit which transmits setting information of the allocated channels.

4. A communication apparatus according to claim 1, wherein the wired communication unit transmits information of distance between the communication apparatus and another communication apparatus.

5. A communication apparatus according to claim 3, wherein the control unit determines whether the communication apparatus interfere with said another communication apparatus or not, based on the distance information.

6. A communication apparatus according to claim 1, wherein the control unit changes allocation of the communication channels in response to a communication channel allocation change command transmitted from the external communication devices.

7. A communication control method using one or more communication apparatuses, each of which performs radio communication with one or more external communication devices by using a plurality of odd-number communication channels and a plurality of even-number communication channels corresponding to certain frequency bands, the method comprising:
allocating the odd-number communication channels in increasing order of frequency and allocating the even-number communication channels in decreasing order of frequency, if channels used for the radio communication with the external communication devices are allocated from among the odd-number communication channels and the even-number communication channels, in accordance with a radio communication environment; and
performing the radio communication with the external communication devices by using the allocated communication channels.

8. A communication control method according to claim 7, wherein, if the number of the communication apparatuses operating are at least two, the communication apparatuses allocate the communication channels until a frequency band of a last allocated odd-number communication channel and a frequency band of a last allocated even-number communication channel are adjacent to each other.

9. A communication control method according to claim 7, wherein:
the communication apparatuses are connected to each other by wired communication unit, and the communication apparatuses shares setting information of the allocated channels.

10. A communication control method according to claim 9, wherein the wired communication unit transmits information of distance between the communication apparatuses.

11. A communication control method according to claim 10, wherein determination as to whether the communication apparatuses interfere with each other or not is performed based on the distance information.

12. A communication control method according to claim 7, wherein allocation of the communication channels is changed in response to a communication channel allocation change command transmitted from the external communication devices.
